(19) United States
(12) Patent Application Publication
(10) Pub. No.: US 2024/0388550 A1
(43) Pub. Date: Nov. 21, 2024

(54) METHOD, COMPUTER DEVICE, AND NON-TRANSITORY COMPUTER-READABLE RECORD MEDIUM TO SHARE CONTENT CREATED IN OTHER CHATROOMS

(71) Applicant: LINE Plus Corporation, Seongnam-si (KR)

(72) Inventors: Chaewon JUNG, Seongnam-si (KR); Soon Hyun KWON, Seongnam-si (KR); Daeun JUNG, Seongnam-si (KR); Seo Hyun CHO, Seongnam-si (KR); SeonYoung KANG, Seongnam-si (KR); EuGene KO, Seongnam-si (KR); Dae Eun YOON, Seongnam-si (KR)

(73) Assignee: LINE Plus Corporation, Seongnam-si (KR)

(21) Appl. No.: 18/658,054

(22) Filed: May 8, 2024

(30) Foreign Application Priority Data
May 16, 2023 (KR) 10-2023-0062862

(51) Int. Cl. H04L 51/046; H04L 51/02

(52) U.S. Cl. CPC H04L 51/046; H04L 51/02

(57) ABSTRACT

Disclosed are a method, a computer device, and a non-transitory computer-readable record medium for sharing content created in another chatroom. A content sharing method may include receiving content created based on a message in a chatroom of another openchat as content of the other openchat set in openchat; and providing the content of the other openchat through at least one page of the openchat.

### CROSS-REFERENCE TO RELATED APPLICATION(S)

This U.S. non-provisional application and claims the benefit of priority under 35 U.S.C. § 119 to Korean Patent Application No. 10-2023-0062862, filed May 16, 2023, the entire contents of which are incorporated herein by reference in their entirety.

### BACKGROUND

### Technical Field

Some example embodiments relate to technology for sharing content through openchat.

### Related Art

An instant messenger that is a general communication tool refers to software that allows a user to send and receive a message or data in real time. The user may register a contact on a messenger and may send and receive messages with a counterpart on a contact list in real time.

Due to such a messenger function, a messenger is commonly used in a mobile environment of a mobile communication terminal as well as a personal computer (PC).

For example, a mobile messenger service system and method of a portable terminal using a wireless communication network to provide a messenger service between mobile messengers installed on mobile terminals are known.

As the use of an instant messenger becomes more popular and functions provided through the instant messenger become more diversified, an openchat function that enables a chat using a link without sharing personal information, such as a telephone number and an ID may be advantageous.

### SUMMARY

Some example embodiments may select a main message in openchat and may create the same as sharable content.

Some example embodiments may share content created in another openchat through various pages of openchat.

Some example embodiments may provide content created in another openchat using a bot invited to openchat.

Some example embodiments may provide content created in another openchat through a specific space within a main screen of openchat.

According to at least one example embodiment, there is provided a content sharing method executed by a computer device, wherein the computer device includes at least one processor configured to execute computer-readable instructions included in a memory, and the content sharing method includes receiving, by the at least one processor, content created based on a message in a chatroom of another openchat as content of the other openchat set in openchat; and providing, by the at least one processor, the content of the other openchat through at least one page of the openchat.

According to an aspect, the providing may include displaying the content of the other openchat on at least one page of a chatroom and a main screen of the openchat.

According to another aspect, the receiving may include receiving the content of the other openchat through a content bot invited by an administrator of the openchat.

According to another aspect, the providing may include displaying the content of the other openchat in the form of a conversation message of the content bot through the chatroom of the openchat.

According to another aspect, the receiving may include receiving the content of the other openchat for which a subscription is set by an administrator of the openchat.

According to another aspect, the providing may include providing the content of the other openchat as a list view or a grid view in a specific space on a main screen of the openchat.

According to another aspect, the providing may include displaying the content of the other openchat included in the list view or the grid view in a sequential and continuous browsing form.

According to another aspect, the content of the other openchat may be created using a main message selected from among messages included in the chatroom of the other openchat.

According to another aspect, the main message may be selected based on at least one of the number of concurrent participants and the number of messages in the same time zone in the chatroom of the other openchat, the average stay time, and a keyword included in a message.

According to another aspect, the main message may be selected based on the average view time of users participating in the chatroom of the other openchat.

According to at least one example embodiment, there is provided a non-transitory computer-readable recording medium storing instructions that, when executed by at least one processor, cause the at least one processor to implement the content sharing method on the computer device.

According to at least one example embodiment, there is provided a computer device including at least one processor configured to execute computer-readable instructions included in a memory, wherein the at least one processor is configured to receive content created based on a message in a chatroom of another openchat as content of the other openchat set in openchat; and provide the content of the other openchat through at least one page of the openchat.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of a computer device according to at least one example embodiment;

FIG. 3 is a flowchart illustrating an example of a method performed by a computer device according to at least one example embodiment;

FIGS. 4 to 6 illustrate examples of describing a process of creating first type chatroom content using a message in a chatroom according to at least one example embodiment; and

FIGS. 7 to 10 illustrate examples of describing a process of sharing second type chatroom content that is content of another openchat through openchat according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Hereinafter, some example embodiments will be described with reference to the accompanying drawings.

Some example embodiments relate to technology for sharing content using openchat.

The example embodiments including disclosures herein may encourage a subscription to openchat and service activation by sharing content created in another openchat through various pages of openchat.

A content sharing system according to some example embodiments may be implemented by at least one computer device. A content sharing method according to some example embodiments may be performed by at least one computer device included in the content sharing system. In some example embodiments, a computer program according to an example embodiment may be installed and run on the computer device and the computer device may perform the content sharing method according to example embodiments under control of the computer program. The aforementioned computer program may be stored in a computer-readable record medium to implement the content sharing method in conjunction with the computer device.

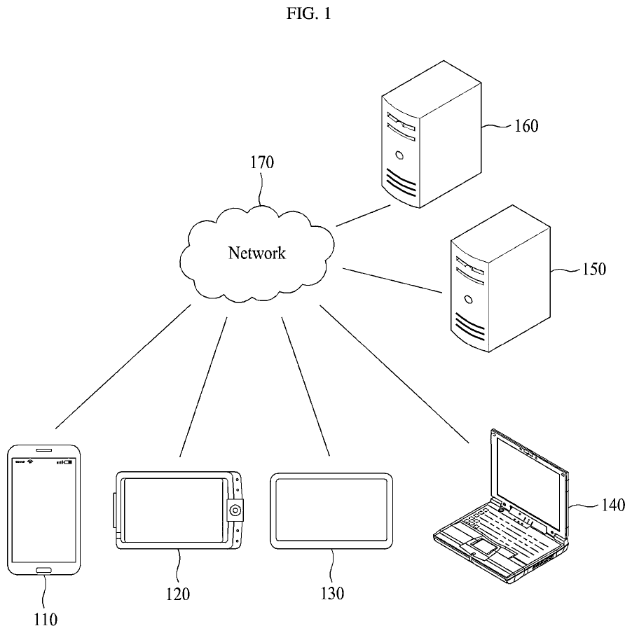

FIG. 1 illustrates an example of a network environment according to at least one example embodiment. Referring to FIG. 1, the network environment may include a plurality of electronic devices 110, 120, 130, and 140, a plurality of servers 150 and 160, and/or a network 170. FIG. 1 is provided as an example only. A number of electronic devices or a number of servers is not limited thereto. Also, the network environment of FIG. 1 is provided as one example of environments applicable to the example embodiments and an environment applicable to the example embodiments is not limited to the network environment of FIG. 1.

Each of the plurality of electronic devices 110, 120, 130, and 140 may be a fixed terminal or a mobile terminal that is configured as a computer device. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, and the like. For example, although FIG. 1 illustrates a shape of a smartphone as an example of the electronic device 110, the electronic device 110 used herein may refer to one of various types of physical computer devices capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, and a broadcasting network.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and the Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a service, for example, a messenger service, to the plurality of electronic devices 110, 120, 130, and 140 connected over the network 170.

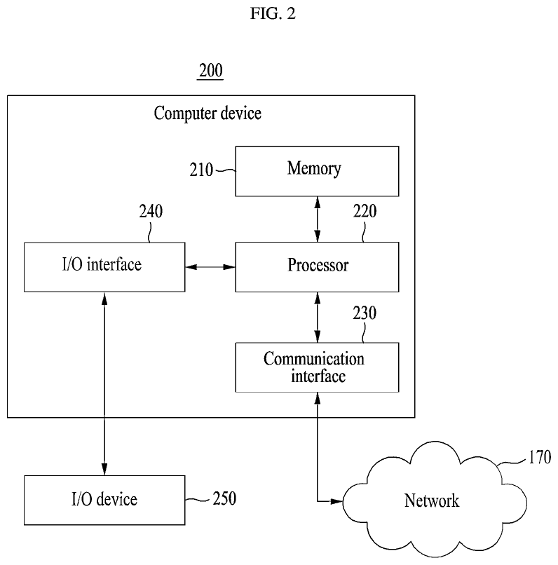

FIG. 2 is a block diagram illustrating an example of a computer device according to at least one example embodiment. Each of the plurality of electronic devices 110, 120, 130, and 140 or each of the servers 150 and 160 may be implemented by a computer device 200 of FIG. 2.

Referring to FIG. 2, the computer device 200 may include a memory 210, a processor 220, a communication interface 230, and/or an input/output (I/O) interface 240. The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer device 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer device 200 based on a computer program installed by files received over the network 170.

The processor 220 may be configured to process instructions of a computer program by performing basic arithmetic operations, logic operations, and I/O operations. The computer-readable instructions may be provided by the memory 210 or the communication interface 230 to the processor 220. For example, the processor 220 may be configured to execute received instructions in response to a program code stored in a storage device, such as the memory 210.

The communication interface 230 may provide a function for communication between the communication apparatus 200 and another apparatus, for example, the aforementioned storage devices over the network 170. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

Also, according to other example embodiments, the computer device 200 may include a greater or smaller number of components than the number of components of FIG. 2. However, there is no need to clearly illustrate most conventional components. For example, the computer device 200 may be configured to include at least a portion of the I/O device 250 or may further include other components, such as a transceiver and a database.

Hereinafter, specific example embodiments of a method and device for sharing content created in another chatroom are described.

A social platform used herein may refer to a service platform that provides various types of services using resources, such as user profile information and friend relationships in a social network service, as well as the social network service, such as a messenger and various communities.

The following example embodiment is described using a messenger as a representative example of the social platform.

Herein, openchat refers to a chat service that allows users to have conversations over a topic of interest and also refers to a community service that allows direct chatting through a link such as a uniform resource locator (URL), without a friend addition process using a telephone number or an ID. An openchat link may include a function that automatically launches a messenger and runs a chatroom of a corresponding ink to allow an immediate chat in response to clicking the link.

The example embodiment may allow content created in another openchat to be shared through various pages, such as a chatroom or a main screen of openchat.

The computer device 200 according to the example embodiment may provide a client with a messenger service through connection to an exclusive application installed on the client or a website/mobile site related to the computer device 200. A content sharing system implemented as a computer may be configured in the computer device 200. For example, the content sharing system may be implemented in the form of a program that independently operates or may be configured in an in-app form of a specific application to be operable on the specific application.

The processor 220 of the computer device 200 may be implemented as a component to perform the following content sharing method. Depending on example embodiments, components of the processor 220 may be selectively included in or excluded from the processor 220. Also, depending on example embodiments, the components of the processor 220 may be separated or merged for functional representation of the processor 220.

The processor 220 and the components of the processor 220 may control the computer device 200 to perform operations included in the following content sharing method. For example, the processor 220 and the components of the processor 220 may be configured to execute an instruction according to a code of at least one program and a code of an OS included in the memory 210.

In some example embodiments, the components of the processor 220 may be representations of different functions performed by the processor 220 in response to an instruction provided from a program code stored in the computer device 200.

The processor 220 may read a necessary instruction from the memory 210 which instructions related to control of the computer device 200 are loaded. In some example embodiments, the read instruction may include an instruction for controlling the processor 220 to perform the following operations.

Operations included in the following content sharing method may be performed in order different from illustrated order. Some of the operations may be omitted or an additional process may be further included.

Operations included in the content sharing method may be performed by the client. Depending on example embodiments, at least some of operations may be performed by the server 150.

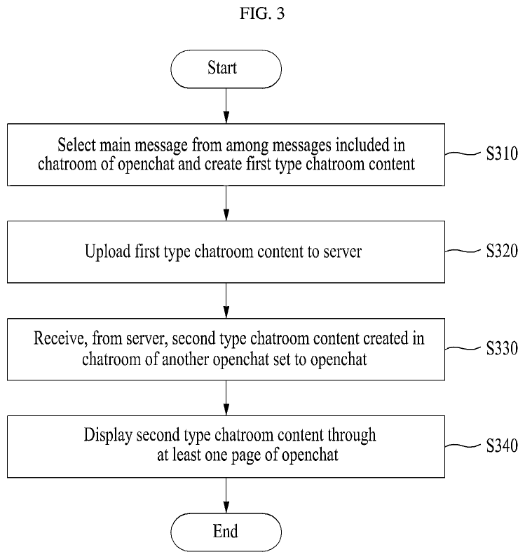

FIG. 3 is a flowchart illustrating an example of a method performed by a computer device according to at least one example embodiment.

Referring to FIG. 3, in operation S310, the processor 220 may select a main message with high participation, popularity, or information from among messages included in a chatroom of openchat with respect to the openchat in which a user joins as a member and may create its own chatroom content (hereinafter, referred to as ‘first type chatroom content’) as secondary content.

In some example embodiments, the processor 220 may select the main message using information derivable from the chatroom, for example, the number of concurrent participants and the number of messages, stay time (e.g., a time value acquired by subtracting a time of entering the chatroom from a time of leaving the chatroom), and a keyword included in a message. For example, the processor 220 may select at least one message as the main message based on a point in time at which the number of users participating in (connected to) the chatroom in the same time zone is greater than or equal to a threshold, a point in time at which the number of messages rapidly increases to be greater than or equal to a threshold, or a point in time at which the average stay time of each user participating in the chatroom is greater than or equal to a threshold. As another example, the processor 220 may select a message that includes a keyword preset by an openchat administrator (admin) as a message that is highly likely to be useful to users in terms of information. The administrator may preset at least one keyword of interest through settings for the openchat chatroom and the processor 220 may select, as the main message, a message that includes a specific keyword set by the administrator from among messages included in the chatroom. In addition to a keyword directly set by the openchat administrator, the processor 220 may select the main message using a keyword that matches a category of the chatroom. As another example, the processor 220 may extract a topic with high topicality by analyzing a conversation pattern in the chatroom and may select a message that matches the corresponding topic as the main message. The processor 220 may extract at least one word that is talked about in the chatroom based on a unit time and may determine a word that exceeds a certain level as the topic with topicality using the probability distribution of topic for each message included in the chatroom. The processor 220 may select, as the main message, a message that includes a keyword identical or similar to each topic from among messages included in the chatroom. As another example, the processor 220 may track a view time of users participating in the chatroom and may select, as the main message, a message in an area with a view greater by at least a certain ratio than the average. As another example, the processor 220 may select the main message based on reactions of other users participating in the chatroom. For example, the processor 220 may select, as the main message, a message in which a positive reaction meets a determined condition, such as like, mention, reply, comment, share, capture, and keep from other users, from among messages included in the openchat chatroom. As another example, the processor 220 may analyze a conversation pattern in the openchat chatroom and may select, as main messages, messages exchanged as questions and responses between other users from among messages included in the chatroom.

The processor 220 may select messages with different timestamps as main messages from among messages included in the openchat chatroom. In some example embodiments, the processor 220 may guarantee a certain time interval between the main messages. For example, when selecting a next main message, the processor 220 may select the next main message from among messages that have passed 5 minutes after a timestamp of a previous main message. The processor 220 may guarantee a time interval of 5 minutes or more between a main message with a timestamp t(n) (integer with n>=0) and a main message with a timestamp t(n+1). Depending on example embodiments, a certain number of messages or more may be guaranteed as a message interval between the main messages. For example, when selecting a next main message, the next main message may be selected from among messages that skipped 100 messages after a previous main message. More than 100 messages may be guaranteed as an interval between the main message with the timestamp t(n) and the main message with the timestamp t(n+1).

The aforementioned main message selection process may be performed on a client side and, depending on a message selection method, the server 150 may select the main message and may deliver information on the selected main message to a client.

The processor 220 may create the main message selected from the chatroom as first type chatroom content sharable through various pages of openchat. For example, the processor 220 may convert the main message to image-typed content through screen capturing of an area that includes the main message in the openchat chatroom. As another example, the processor 220 may convert the main message to video-typed content through screen recording of an area that includes the main message in the chatroom. The first type chatroom content in the form of video may be created in various types of content, such as graphics interchange format (GIF) in which main messages are sequentially displayed in temporal order using graphic technology, such as animation and effect, in addition to screen recording.

In operation S320, the processor 220 may upload, to the server 150, the first type chatroom content created by converting the main message included in the openchat chatroom with respect to the openchat in which the user joins as a member. In some example embodiments, the server 150 may manage the first type chatroom content created as the main message in a chatroom of each openchat by openchat in association with corresponding openchat.

In operation S330, the processor 220 may receive, from the server 150, content (hereinafter, referred to as ‘second type chatroom content’) created as a main message in a chatroom of another openchat set to the corresponding openchat with respect to the openchat in which the user joins as the member. A second type chatroom content creation process is also the same as the aforementioned first type chatroom content creation process. For example, the openchat administrator may invite a bot (hereinafter, referred to as a ‘content bot’) to the openchat administrator's openchat to provide the second type chatroom content that is the content of the other openchat. In some example embodiments, the content bot may fetch the second type chatroom content that is the content of the other openchat from the server 150, periodically or according to a predetermined or alternatively, desired rule (e.g., when the user inputs a selection of the content bot in the chatroom), while participating in the openchat of the corresponding administrator through invitation from the administrator. According to an example embodiment, when the content bot participates in the chatroom through invitation from the administrator, contents that may attract interest of chatroom members may be recommended by the content bot even without an additional input from the administrator or a chatroom member. In some example embodiments, the content bot may determine another openchat or another openchat chatroom based on at least one of an openchat name, a chatroom name of openchat, an openchat category, analysis of openchat members, and/or results of analyzing message contents in the openchat chatroom, and may recommend comment created by the determined other openchat and/or the openchat chatroom. Alternatively, the content bot may select and recommend content created by the other openchat and/or openchat chatroom based on at least one of an openchat name, a chatroom name of openchat, an openchat category, analysis of openchat members, and/or results of analyzing message contents in the openchat chatroom. As another example, the openchat administrator may set a subscription for a similar topic or another openchat of interest in relation to the openchat administrator's openchat. In some example embodiments, the processor 220 may fetch the second type chatroom content, which is the content of the other openchat for which the subscription is set, from the server 150 to the openchat in which the user joins as the member.

In operation S340, the processor 220 may display the second type chatroom content received in operation S330 through at least one page of the openchat in which the user joins as the member. In some example embodiments, when receiving the second type chatroom content using the content bot participating in the openchat, the processor 220 may display the second type chatroom content in the form of a message of the content bot through the chatroom of the corresponding openchat. Within the openchat chatroom, the second type chatroom content may be provided in the form of a conversation message of the content bot and openchat information that is a content source may be provided to make it possible to identify corresponding openchat of the content. Also, in example embodiments of receiving the second type chatroom content through subscription settings, the processor 220 may display the received second type chatroom content in a list form on a main screen of the openchat. A specific space, such as a bulletin board dedicated to content for displaying the second type chatroom content may be included in the main screen of the openchat. The processor 220 may display items corresponding to the second type chatroom content in a list form in the specific space on the openchat main screen and may provide the second type chatroom content included in a list as a user experience (UX) that allows continuous browsing. In addition to providing the second type chatroom content as a list view in the specific space on the openchat main screen, the second type chatroom content may be provided using various view modes, such as a grid view.

Therefore, the processor 220 may select the main message in the openchat and may create content sharable through another openchat and may provide the second type chatroom content, which is the content of the other openchat in which the user has not joined, but may be interested, through a page of the openchat in which the user joins as the member.

Hereinafter, description is made assuming openchatA in which a user does not join as a member and openchatB in which the user joins as a member.

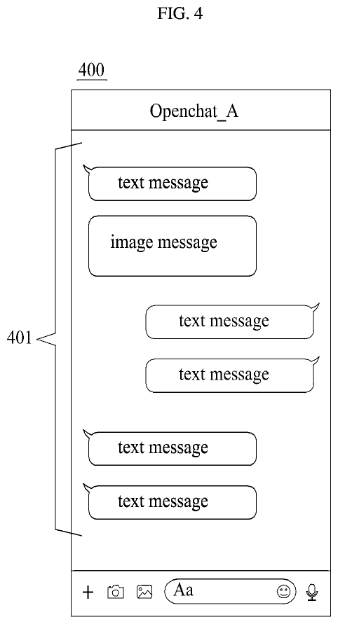

FIGS. 4 to 6 illustrate examples of describing a process of creating first type chatroom content using a message in a chatroom according to at least one example embodiment.

FIG. 4 illustrates an openchatA chatroom 400. Messages 401 exchanged between users participating in openchatA may be included in the openchatA chatroom 400. The messages 401 may include any type of messages sharable through a chatroom, such as text, image, audio, sticker (or emoticon), and document.

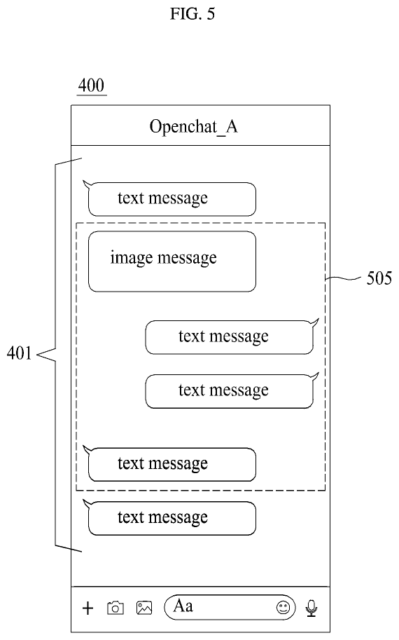

Referring to FIG. 5, the processor 220 may select main messages 505 with high participation, popularity, or information, from among the messages 401 included in the openchatA chatroom 400.

The processor 220 may select the main messages 505 using the number of concurrent participants and the number of messages, stay time, and a keyword included in a message. For example, the processor 220 may determine, as the main message 505, a message corresponding to a point in time at which a large number of users are instantaneously connected in the same time zone, a point in time at which the number of messages rapidly increases in the same time zone, or a point in time at which the average stay time for each user is long.

As another example, the processor 220 may select the main message 505 using a keyword included in the messages 401. For example, the processor 220 may classify the messages 401 that include a keyword directly set by an openchatA administrator or a keyword that matches a category of openchatA as the main messages 505.

Depending on example embodiments, the processor 220 may track a view time of users participating in the openchatA chatroom 400 and may classify the messages 401 in an area with a view greater by at least a certain ratio than the average as the main messages 505.

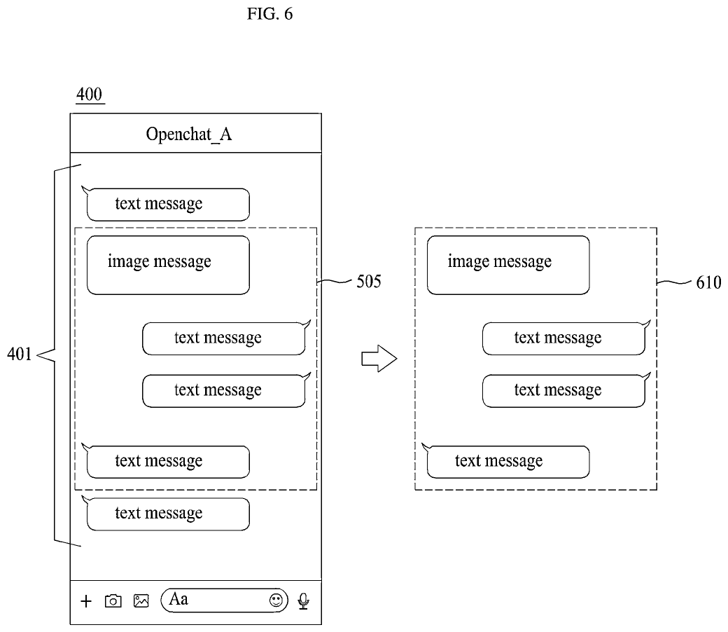

Referring to FIG. 6, the processor 220 may create the main messages 505 selected in the openchatA chatroom 400 as content 610 in the form of image or video. For example, the processor 220 may create an area that includes the main messages 505 in the openchatA chatroom 400 as first type chatroom content 610 of the openchatA by converting the area to content through a screen capturing or screen recording method.

Therefore, the processor 220 may select the main messages 505 from among the messages 401 in the openchatA chatroom 400 and may create the first type chatroom content 610 of the openchatA.

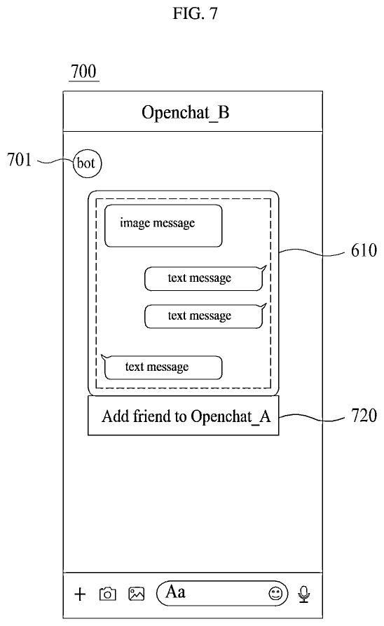

FIGS. 7 to 10 illustrate examples of describing a process of sharing second type chatroom content that is content of another openchat through openchat according to at least one example embodiment.

FIG. 7 illustrates an openchatB chatroom 700 in which a user joins as a member. A content bot 701 may be included in openchatB as a member participating in conversation through visitation from an administrator.

Referring to FIG. 7, the processor 220 may display the content 610 created in an openchatA chatroom as not content of openchatB but second type chatroom content in the openchatB chatroom 700 using the content bot 701. The content bot 701 may fetch the content 610 of the openchatA from the server 150 and may display the same in the openchatB chatroom 700 periodically or in response to a request from a user participating in the openchatB.

In some example embodiments, the content 610 of the openchatA may be displayed in the form of a conversation message of the content bot 701 and openchat information 720 that is a content source may also be provided. The openchat information 720 may include a cover concept page (hereinafter, referred to as ‘cover page’) linked to the openchatA that is a content source or link information to connect to the chatroom of the openchatA to encourage a subscription to openchat.

A user participating in the openchatB may share the content 610 of the openchatA through the content bot 701 and may acquire openchat identification information, such as content of which openchat, through the openchat information 720.

Only with respect to openchat that adds the content bot 701 as a member participating in conversation, the content 610 of the openchatA that is the second type chatroom content may be provided through the content bot 701.

In addition to providing the second type chatroom content using the content bot 701, the second type chatroom content may also be displayed on another screen, such as an openchat main screen.

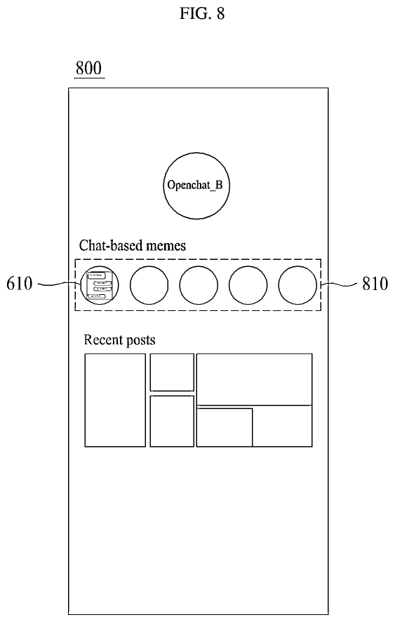

FIG. 8 illustrates a main screen of openchatB in which a user joins as a member (hereinafter, referred to as ‘openchatB main screen’ 800). It is assumed that an openchatB (or openchatB chatroom) administrator has set a subscription to openchatA.

Referring to FIG. 8, a specific space 810, such as a bulletin board dedicated to content for displaying second type chatroom content, may be included in the openchatB main screen 800.

The processor 220 may display items corresponding to the second type chatroom content in the specific space 810 on the openchatB main screen 800. Contents of another openchat to which the user is subscribing in openchatB may be included in a content list of the specific place 810. In some example embodiments, the content 610 of openchatA may be included.

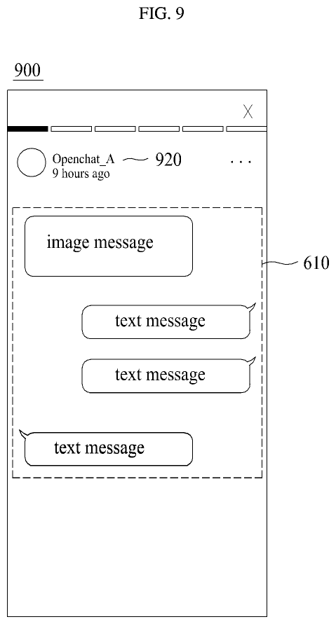

The processor 220 may provide the second type chatroom content included in the specific space 810 as UX in a continuous browsing manner. For example, referring to FIG. 9, in response to a user request, the processor 220 may sequentially display the second type chatroom contents included in a list of the specific space 810 in content creation time order through a second type chatroom content browsing screen 900. In some example embodiments, the second type chatroom contents may be displayed sequentially from most recently created second type chatroom content or user-selected second type chatroom content in the content list.

The processor 220 may display the content 610 of the openchatA as the second type chatroom content through the second type chatroom content browsing screen 900 in response to the user request. The processor 220 may also provide openchat information 920 that is a content source at a point in time at which the content 610 of the openchatA is displayed. A cover page linked to the openchatA that is a content source or link information for connecting to the openchatA chatroom may be included in the openchat information 920 to encourage a subscription to openchat.

The second type chatroom content may be displayed in the form of moving to openchat corresponding to the content source or an openchat chatroom in addition to a continuous browsing type interface.

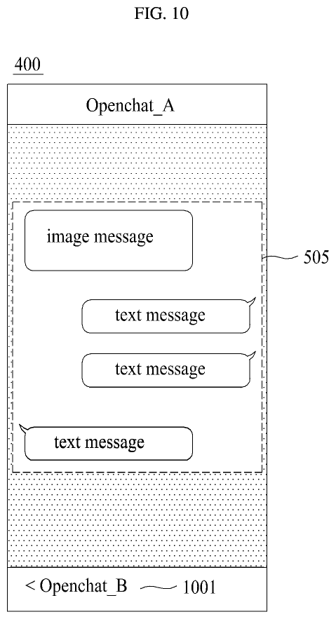

For example, when the content 610 of the openchatA is selected from the content list in the specific space 810 on the openchatB main screen 800, it is possible to move to the openchatA chatroom 400 as shown in FIG. 10. In some example embodiments, the processor 220 may move from the openchatB main screen 800 to the openchatA chatroom 400 and may automatically scroll to an area that includes the main messages 505 created as the content 610 of the openchatA.

The processor 220 may display only the main messages 505 corresponding to the content 610 in an identifiable form among the messages included in the openchatA chatroom 400 and may display messages in a remaining area in a de-identified form.

A back button 1001 to return to the openchatB main screen 800 that is a previous service screen may be included in the openchatA chatroom 400 moved to verify the second type chatroom content.

Therefore, the processor 220 may invite the content bot 701 as a member and may share the content 100 of the openchatA through the openchatB chatroom 700 accordingly and, depending on example embodiments, may share the content 610 of the openchatA through the openchatB main screen 800 using a subscription setting method.

As described above, according to example embodiments, it is possible to encourage openchat subscription and service activation by sharing content created in another openchat through various pages of openchat. In some example embodiments, in the example embodiment, it is possible to set another openchat for content sharing through a method of inviting a content bot or setting a subscription to openchat and to acquire and share the second type chatroom content through corresponding setting.

The apparatuses described above may be implemented using hardware components, software components, and/or combination thereof. For example, the apparatuses and components described herein may be implemented using one or more general-purpose or special purpose computers, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For simplicity, the description of the processing device is used as singular; however, one skilled in the art will be appreciated that the processing device may include multiple processing elements and/or multiple types of processing elements. For example, the processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, a computer storage medium or device, or in a propagated signal wave capable of providing instructions or data to or being interpreted by the processing device. The software also may be distributed over network coupled computer devices so that the software is stored and executed in a distributed fashion. The software and data may be stored by one or more computer readable storage mediums.

The methods according to some example embodiments may be configured in a form of program instructions performed through various computer methods and recorded in non-transitory computer-readable media. The media may continuously store computer-executable programs or may temporarily store the same for execution or download. Also, the media may be various types of recording devices or storage devices in a form in which one or a plurality of hardware components are combined. Without being limited to media directly connected to a computer device, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by an app store that distributes applications or a site, a server, and the like that supplies and distributes other various types of software.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents. Therefore, other implementations, other example embodiments, and equivalents are within the scope of the following claims.

What is claimed is:

1. A content sharing method executed by a computer device, wherein:
the computer device comprises at least one processor configured to execute computer-readable instructions included in a memory, and
the content sharing method comprises:
receiving, by the at least one processor, content created based on a message in a chatroom of another openchat as content of the other openchat set in openchat; and
providing, by the at least one processor, the content of the other openchat through at least one page of the openchat.

2. The content sharing method of claim 1, wherein the providing comprises displaying the content of the other openchat on at least one page of a chatroom and a main screen of the openchat.

3. The content sharing method of claim 1, wherein the receiving comprises receiving the content of the other openchat through a content bot invited by an administrator of the openchat.

4. The content sharing method of claim 3, wherein the providing comprises displaying the content of the other openchat in the form of a conversation message of the content bot through the chatroom of the openchat.

5. The content sharing method of claim 1, wherein the receiving comprises receiving the content of the other openchat for which a subscription is set by an administrator of the openchat.

6. The content sharing method of claim 5, wherein the providing comprises providing the content of the other openchat as a list view or a grid view in a specific space on a main screen of the openchat.

7. The content sharing method of claim 6, wherein the providing comprises displaying the content of the other openchat included in the list view or the grid view in a sequential and continuous browsing form.

8. The content sharing method of claim 1, wherein the content of the other openchat is created using a main message selected from among messages included in the chatroom of the other openchat.

9. The content sharing method of claim 8, wherein the main message is selected based on at least one of the number of concurrent participants and the number of messages in the same time zone in the chatroom of the other openchat, the average stay time, and a keyword included in a message.

10. The content sharing method of claim 8, wherein the main message is selected based on the average view time of users participating in the chatroom of the other openchat.

11. A non-transitory computer-readable recording medium storing instructions that, when executed by at least one processor, cause the at least one processor to implement the content sharing method of claim 1 on the computer device.

12. A computer device comprising:
at least one processor configured to execute computer-readable instructions included in a memory,
wherein the at least one processor is configured to:
receive content created based on a message in a chatroom of another openchat as content of the other openchat set in openchat; and
provide the content of the other openchat through at least one page of the openchat.

13. The computer device of claim 12, wherein the at least one processor is configured to display the content of the other openchat on at least one page of a chatroom and a main screen of the openchat.

14. The computer device of claim 12, wherein the at least one processor is configured to receive the content of the other openchat through a content bot invited by an administrator of the openchat.

15. The computer device of claim 14, wherein the at least one processor is configured to display the content of the other openchat in the form of a conversation message of the content bot through the chatroom of the openchat.

16. The computer device of claim 12, wherein the at least one processor is configured to receive the content of the other openchat for which a subscription is set by an administrator of the openchat.

17. The computer device of claim 16, wherein the at least one processor is configured to provide the content of the other openchat as a list view or a grid view in a specific space on a main screen of the openchat.

18. The computer device of claim 17, wherein the at least one processor is configured to display the content of the other openchat included in the list view or the grid view in a sequential and continuous browsing form.

19. The computer device of claim 12, wherein the content of the other openchat is created using a main message selected from among messages included in the chatroom of the other openchat.

20. The computer device of claim 19, wherein the main message is selected based on at least one of the number of concurrent participants and the number of messages in the same time zone in the chatroom of the other openchat, the average stay time, and a keyword included in a message.
